(19) United States
(12) Patent Application Publication
(10) Pub. No.: US 2011/0044151 A1
(43) Pub. Date: Feb. 24, 2011

(54) ELECTRONIC DEVICE

(75) Inventors: Taiichi MORI, Fukuoka (JP); Hideaki HORIO, Fukuoka (JP); Shouhei INOUE, Fukuoka (JP); Syougo HORINOUCHI, Fukuoka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/858,111

(22) Filed: Aug. 17, 2010

(30) Foreign Application Priority Data
Aug. 20, 2009 (JP) P.2009-190629

(51) Int. Cl. G11B 7/00

(52) U.S. Cl. 369/103; G9B/7

(57) ABSTRACT

An electronic device that performs at least reading or regeneration of data in or from a hologram disc is characterized by including an objective lens 11 disposed opposite a hologram disc (MH) 1; a laser light source 5 that emits a beam toward the objective lens 11; and a light receiving element 17 that receives a beam reflected from the hologram disc (MH) 1 by way of the objective lens 11, wherein a corner cube array 8 that reflects a portion of a beam traveling from the laser light source 5 toward the objective lens 11 is interposed between the laser light source 5 and the objective lens 11.

### BACKGROUND

1. Field of the Invention

The present invention relates to an electronic device that performs at least recording or regeneration of data in or from a hologram disc.

2. Description of the Related Art

With a view toward increasing recording volume, a multilevel-recorded hologram disc has recently been proposed.

Since hologram layers that are recording layers are stacked in layers in an interior of a circular-disc-shaped hologram disc along its thicknesswise direction, a recording volume of the hologram disc becomes considerably large.

In an electronic device that performs recording or regeneration of data in and from a hologram disc, a beam emitted from a light emitting element is collected by an objective lens, and the beam is irradiated on one side of the hologram disc, thereby performing recording or regeneration of data in or from the hologram disc. Multilevel recording is implemented by changing a relative distance between the hologram disc and the objective lens.

Patent Document 1: U.S. Pat. No. 7,388,695

However, when the related art hologram disc is subjected to regeneration, an intensity of a regeneration beam reflected from a hologram layer is smaller than an intensity of a beam irradiated on the hologram disc. Some electronic devices cannot read a regeneration beam, and hence read accuracy might be deteriorated.

### SUMMARY

Accordingly, the present invention aims at enhancing read accuracy.

The present invention provides an electronic device that performs at least recording or regeneration of data in or from a hologram disc, characterized by including: an objective lens disposed opposite the hologram disc; a light emitting element that emits a beam toward the objective lens; and a light receiving element that receives a beam reflected from the hologram disc by way of the objective lens, wherein a reflection plate for reflecting a portion of a beam traveling from the light emitting element toward the objective lens is interposed between the light emitting element and the objective lens.

As mentioned above, in the present invention, the reflection plate for reflecting a portion of the beam traveling from the light emitting element toward the objective lens is interposed between the light emitting element and the objective lens. The beam that is reflected from the reflection plate and that has higher intensity than that of a regeneration beam can be utilized when a beam traveling from the objective lens toward the light receiving element; namely, the regeneration beam, is read. Hence, the regeneration beam can be read with reliability, and read accuracy can be enhanced.

### BRIEF DESCRIPTION OF THE DRAWINGS

FIG. 1 is a schematic diagram of an electronic device of a first embodiment of the present invention;

FIG. 2 is a perspective view showing a hologram disc (a recoding medium) of the first embodiment of the present invention;

FIG. 3 is a partially enlarged oblique perspective view of FIG. 2;

FIG. 4 is a partially enlarged plan view showing the hologram disc (the recording medium) of the first embodiment of the present invention;

FIG. 5 is a characteristic diagram showing an energy level of a laser beam (a circular beam) 5A shown in FIG. 4;

FIG. 6 is a partially enlarged plan view showing regeneration that the hologram disc shown in FIG. 4 undergoes;

FIGS. 7 (a), (b), (c) and (d) are diagrams showing tracking control performed when the hologram disc shown in FIG. 4 undergoes regeneration;

FIG. 8 is an operation diagram achieved during regeneration operation of the electronic device of the first embodiment of the present invention;

FIG. 9 is a diagram showing coherence of a beam;

FIG. 10 is a schematic diagram of an electronic device of a second embodiment of the present invention;

FIGS. 11 (a) and (b) are waveform charts for describing operation of a comparative example;

FIGS. 12 (a) and (b) are waveform charts for describing operation of the electronic device of the second embodiment of the present invention;

FIGS. 13 (a), (b), (c) and (d) are waveform charts for describing operation of the electronic device of the second embodiment of the present invention; and

FIG. 14 (a), (b) are waveform charts for describing operation of the electronic device of the second embodiment of the present invention.

### DETAILED DESCRIPTION

The present invention relates to an electronic device that performs at least recording or regeneration of data in or from a hologram disc. The electronic device is characterized by including an objective lens disposed opposite the hologram disc, a light emitting element that emits a beam toward the objective lens, and a light receiving element that receives a beam reflected from the hologram disc by way of the objective lens, wherein a reflection plate for reflecting a portion of the beam traveling from the light emitting element toward the objective lens is interposed between the light emitting element and the objective lens.

On occasion of reading of the beam traveling from the objective lens toward the light receiving element; i.e., a regeneration beam, a beam that is greater than the regeneration beam in terms of intensity and that has been reflected from the reflection plate can be utilized for amplifying the regeneration beam. Therefore, the regeneration beam can be read with reliability, so that the read accuracy can be enhanced.

The reflection plate permits transmission of only an outer peripheral portion of the beam traveling from the light emitting element toward the objective lens but reflects an inner peripheral portion of the beam, with the result that a correction can be made to spherical aberration stemming from a change in the position at which the beam is collected.

The reflection plate permits transmission of the beam originating from the objective lens toward the light receiving element, whereby the beam reflected from the hologram disc can efficiently be utilized.

Polarized beam of a beam from the light emitting element that enters the reflection plate, to thus undergo reflection on or transmit through the reflection plate, and polarized beam of another beam that re-enters the reflection plate after having undergone reflection on the hologram disc are substantially orthogonal to each other. As a result, on occasion of reading of a regeneration beam, efficiency of utilization of the beam, which is greater than the regeneration beam in terms of intensity and which has been reflected from the reflection plate, for amplification of the regeneration beam can be maximized.

A diffraction grating for splitting the beam traveling from the objective lens and the reflection plate toward the light receiving element into three beams; namely, a first beam, a second beam, and a third beam, is interposed between the objective lens and the light receiving element. When the light receiving element reads the first beam and the second beam, the first beam is split into two mutually orthogonal polarized beams. Further, after a state of polarized beam of the second beam has been changed, the second beam is into two mutually orthogonal polarized beams. The respective polarized beams are read, whereby the beam reflected from the hologram disc can be read, while amplified, by utilization of the beam reflected from the reflection plate.

The third beam can be utilized at least for focus control or tracking control.

The reflection plate has a corner cube array in which a plurality of corner cubes are arranged in a plane; a first member disposed on an incident plane side of the reflection plate where the beam emitted from the light emitting element enters; and a second member disposed on another side of the reflection plate opposite to its incident plane side. The first member and the second member of the corner cube array are integrally formed. The first member and the second member have the same reflective index, so that the beam passing through the reflection plate can correctly be guided.

The light emitting element is a semiconductor laser. A difference between an optical path length of the beam traveling toward the light receiving element after having undergone reflection on the reflection plate and an optical path length of the beam traveling toward the light receiving element after having undergone reflection on the hologram disc is substantially an integral multiple of a value that is twice an optical cavity length of the semiconductor laser. As a result, coherence between the beam traveling toward the light receiving element after having undergone reflection on the reflection plate and the beam traveling toward the light receiving element after having undergone reflection on the hologram disc is increased. Efficiency of operation for reading, in an amplifying manner, the beam reflected from the hologram disc by utilization of the beam reflected from the reflection plate is increased.

### EMBODIMENTS

Embodiments of the present invention are hereunder described by reference to the drawings.

### First Embodiment

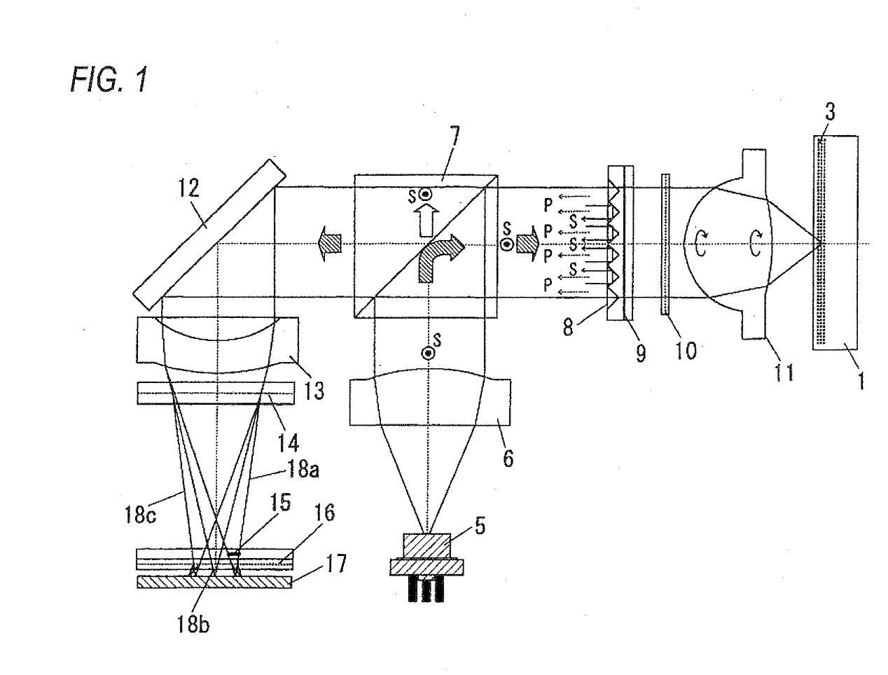

FIG. 1 shows an electronic device that performs recording and regeneration of data in and from a hologram disc (MH) 1. First, an explanation is given to the hologram disc (MH) 1, and the electronic device that performs recording and regeneration of data in and from the disc is subsequently described.

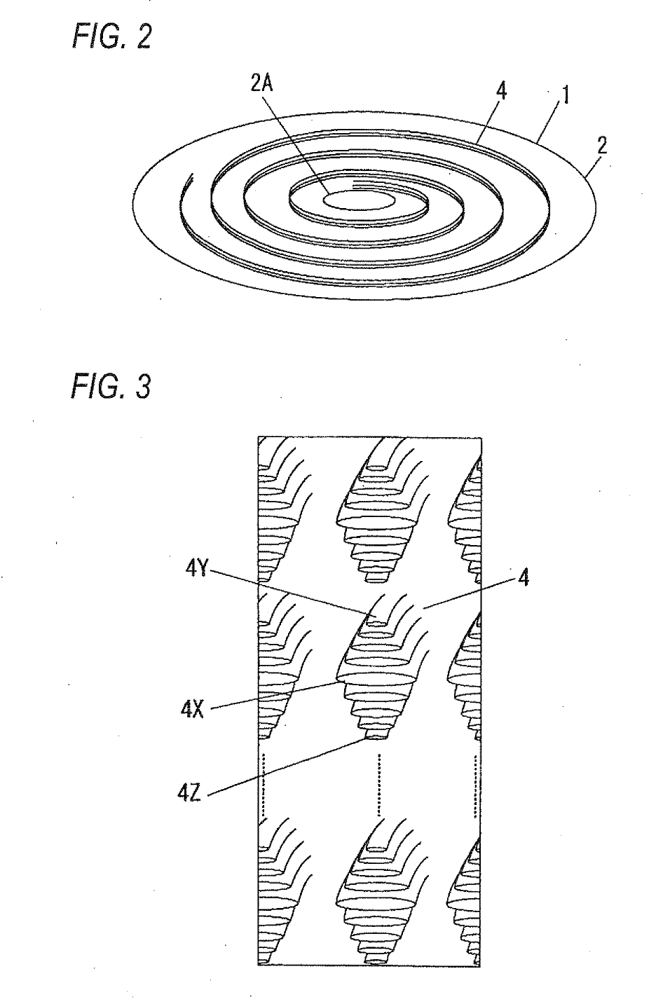

The hologram disc (MH) 1 shown in FIG. 1 is made up of a circular-disc-shaped plate element 2 as shown in FIG. 2. A drive shaft (not shown) of the electronic device is inserted into a through hole 2A for rotational driving purpose opened in a center of the plate element 2. The hologram disc (MH) 1 is thereby rotationally driven.

As shown in FIG. 1, the hologram disc (MH) 1 used in the embodiment includes a plurality of helical hologram layers 3 previously formed at predetermined intervals in the plate element 2 along its thicknesswise direction.

As can be understood from FIGS. 2 and 3, each of the helical hologram layers 3 is made up of a helical hologram strip 4. The helical hologram strip 4 of an individual layer is separated from a helical hologram strip 4 of an upper layer and also from a helical hologram strip 4 of a lower layer. In other words, in the present embodiment, outer peripheral ends and inner peripheral ends of the respective helical hologram strips 4 of the respective layers are vertically separated at predetermined intervals from each other. Hence, layer information showing a layer number is provided in the vicinity of the inner peripheral end of each of the helical hologram strips 4.

As a matter of course, the helical hologram strip 4 can also be made continual, in a unicursal pattern, from an upper level to a lower level.

As mentioned above, in the present embodiment, the plurality of helical hologram layers 3 laid at predetermined intervals in the vertical direction are formed in the plate element 2. During recording operation, the helical hologram strip 4 making up the helical hologram layer 3 is irradiated with a beam, thereby inducing optical alteration. The helical hologram strip 4 located in the irradiated area thereby disappears (e.g., a digital 0). The helical hologram strip 4 located in an unexposed area is held in its original state; namely, a non-disappeared state (e.g., a digital 1). Intermittent digital recording can thereby be performed in the form of digital 0s and 1s along a circumferential direction.

During regeneration operation, data are regenerated by reading digital 0 and 1 signal.

As mentioned above, one of the characteristics of the present embodiment lies in that each of the helical hologram layers 3 is formed from the continual helical hologram strip 4 as shown in FIGS. 2 and 3.

Each of the helical hologram strips 4 has, in its vertical direction, a plurality of interference fringes as shown in FIG. 3. Among the vertically-arranged interference fringes, an intermediate layer (e.g., 4X) located in the vertical direction has a larger width (in a direction orthogonal to a longitudinal direction of the helical hologram strip 4). An upper layer (e.g., 4Y) located above the intermediate layer (e.g., 4X) has a smaller width, and a lower layer (e.g., 4Z) located below the intermediate layer (e.g., 4X) also has a smaller width.

By reference to FIGS. 1 through 3, the electronic device that records and regenerates data in and from the helical hologram strip 4 formed in the hologram disc (MH) 1 is now described.

The electronic device that records and regenerates data in and from the hologram disc (MH) 1 includes a laser light source 5 that oscillates a laser beam; a collimator lens 6 that converts a beam from the laser light source 5 into a collimated beam; a beam splitter 7 that splits a beam from the collimator lens 6; a corner cube array 8 with a polarized beam selective film that reflects a specific polarized component of the beam at a predetermined ratio; a quarter wavelength plate 9; a liquid crystal spherical aberration correction plate 10 that corrects spherical aberration resulting from a change in a position at which a beam is collected on the hologram disk (MH) 1; an objective lens 11; a reflection plate 12; an astigmatizer lens 13; a diffraction grating 14 that splits an incident beam into three beam, i.e., a zero^{th} order beam, a +1^{st} order beam, and a −1^{st} order beam; a quarter wavelength plate 15 that changes a polarized state of an incident beam; a polarized beam hologram 16 that splits an incident beam into two mutually orthogonal polarized beams having substantially equal amounts of light; and a light receiving element 17 that receives a beam from the hologram disc (MH) 1.

In the present embodiment, a normal laser light source is used as the laser light source 5. However, use of an external cavity laser diode (ECLD) is preferable.

In the embodiment, the corner cube array 8 and the quarter wavelength plate 9 are integrally formed on; e.g., a glass substrate.

At this time, if the laser is configured such that a difference exists between a refractive index of a member situated on the side of the corner cube array 8 facing the beam splitter 7 (an incident plane side of the corner cube array 8 where the beam from the laser light source 5 enters) and a refractive index of a member situated on the side of the corner cube array 8 facing the spherical aberration correction plate 10 (i.e., the side of the array opposite to its incident plane side); namely, that a change takes place in refractive index before and after the corner cube array 8, and the beam passed through the corner cube array 8 after having undergone reflection on the hologram disc (MH) 1 may undergo refraction and cannot correctly be guided to the beam splitter 7. Therefore, the laser must be configured from members having the same refractive index such that a change does not arise in refractive index along the corner cube array 8 that is a boundary.

For this reason, when the corner cube array 8 is formed from glass, or the like, integrally along with the quarter wavelength plate 9, quarter wavelength plates having the same refractive index as that of the corner cube array are used on both sides of the corner cube array 8, thereby preventing occurrence of a change in refractive index before and after the corner cube array 8.

The essential requirement for the refractive index is to be identical with a wavelength of a beam (e.g., 405 nm in the embodiment) from the laser light source 5.

The corner cube array 8 is now described. The corner cube array 8 is provided with a reflection coating that reflects a specific polarized component (an S polarized beam in the embodiment) of the laser beam at a predetermined ratio. The corner cube array reflects an input S polarized beam in the same direction where the beam has entered. In the embodiment, the corner cube array is provided in numbers and in the form of a shape made by combination of three planar plates at right angle. The corner cube array is formed in a planar form. In the embodiment, 90% of the S polarized beam is reflected.

There is now described the electronic device that records and regenerates data in and from the helical hologram layer 3 formed in the hologram disc (MH) 1.

First, operation of the electronic device performed during recording is described.

In FIG. 1, for instance, a blue laser beam (a wavelength of 405 nm) emitted as an S polarized beam from the laser light source 5 passes through the collimator lens 6.

A half of the laser beam passed through the collimator lens 6 undergoes reflection on the beam splitter 7, to thus travel toward the objective lens 11. A remaining half of the laser beam passes through the beam splitter 7.

A half of the laser beam reflected from the beam splitter 7 undergoes reflection on the corner cube array 8. A remaining half of the laser beam passes through the corner cube array 8, to thus pass through the quarter wavelength plate 9 and the spherical aberration correction plate 10. The beam is then irradiated as a circularly polarized beam on the target helical hologram strip 4 by means of the objective lens 11, whereby recording is performed.

In order to obtain a focus on a target layer (a depthwise layer), there is provided variable means (which is well known and not illustrated to avoid complication of the drawings) that changes a relative distance between the objective lens 11 and the hologram disc (MH) 1.

Since recording operation is carried out, the laser beam irradiated on the helical hologram strip 4 is intensified (about 10 times the intensity of the laser beam achieved during reading operation). Optical alteration arises in an area of the helical hologram strip 4 irradiated with the laser beam, and a hologram in the thus-irradiated area disappears. Further, no optical alteration arises in a remaining, un-irradiated area of the helical hologram strip 4, and the area enters a non-disappeared state. Specifically, digital recording; namely, so-called recording involving a digital 0 signal and a digital 1 signal, is performed.

In the embodiment, the blue laser beam emitted from the laser light source 5 during recording operation is irradiated on the helical hologram strip 4 of a target layer, thereby letting the irradiated area of the helical hologram strip 4 disappear.

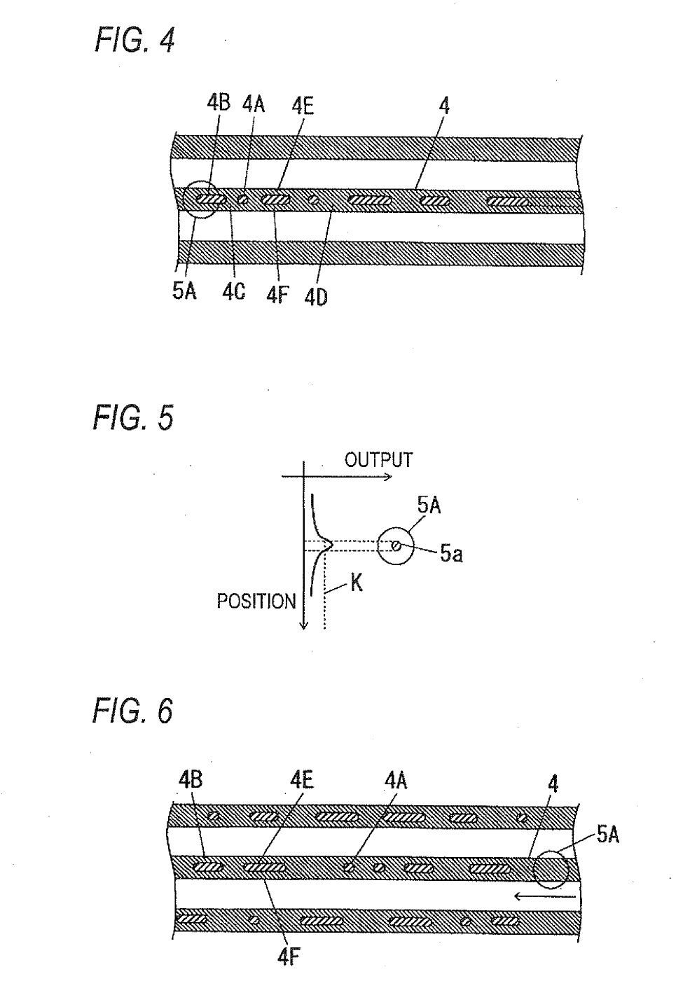

Areas 4A and 4B shown in FIG. 4 become a disappeared area (e.g. a digital 0 signal) of the helical hologram strip 4. The disappeared area 4A is a single disappeared area, and reference numeral 4B designates a state in which the disappearing area 4A is continually formed in a longitudinal direction of the helical hologram strip 4.

The helical hologram strip 4 other than the disappeared areas 4A and 4B has become; for instance, non-disappeared areas 4C and 4D (e.g., a digital one signal). Of these areas, a non-disappeared area 4C is a single non-disappeared area, and reference numeral 4D denotes a state in which the non-disappeared area 4C is continually formed.

In the embodiment, reference numeral 5A provided in the disappeared area 4B shown in FIG. 4 designates a blue laser beam (a circular beam) that has originated from the laser light source 5 and that has been irradiated on the helical hologram strip 4.

What is important here is that, during recording operation of the present embodiment, the blue laser beam (the circular beam) 5A irradiated on the helical hologram 4 is formed, as shown in FIG. 5, such that a portion of the laser beam whose energy exceeds an energy level K becomes smaller than a width of the helical hologram strip 4 achieved in a direction orthogonal to its longitudinal direction. In the embodiment, the laser beam (the circular beam) 5A employed during recoding operation is hereinbelow expressed as a small-diameter laser beam 5A shown in FIG. 5.

A more characteristic thing is that the small-diameter laser beam 5A (a circular beam) achieved during recording operation is irradiated so as to sweep along a center line area of the helical hologram strip 4 with respect to its longitudinal direction in such a way that an un-irradiated area is formed on both longitudinal sides of the hologram strip 4, as shown in FIG. 4.

Specifically, in so doing, when the laser beam (the circular beam) 5A is emitted from the laser light source 5 during recording operation as shown in FIG. 4, disappeared areas 4A, 4B and non-disappeared areas 4C, 4D are formed in the helical hologram strip 4 in its longitudinal direction. Further, even in the disappeared areas 4A and 4B, non-disappeared areas 4E and 4F of the helical hologram strip 4 are formed on both sides of the helical hologram strip 4 along a direction orthogonal to its longitudinal direction.

As can be understood from FIG. 3, holograms (4X and holograms located in the vicinity thereof) are present in the non-disappeared areas 4E and 4F. Hence, in the embodiment, remaining holograms (4X and holograms located in the vicinity thereof) are utilized as tracking information even in the non-disappeared areas 4E and 4F.

As a matter of course, in the non-disappeared areas 4C and 4D, the holograms shown in FIG. 3 (4X and the holograms located in the vicinity thereof) are likewise present on both sides of the helical hologram strip 4 orthogonal to its longitudinal direction. As a consequence, tracking information areas are formed on both sides of the helical hologram strip 4 orthogonal to its longitudinal direction. Appropriate tracking control can be performed by utilization of tracking information from the tracking information areas.

Such tracking information areas are formed even in the helical hologram strips 4 of inner layers. Hence, even at the time of recording and regeneration of data in and from the helical hologram strip 4 of the inner layer, appropriate tracking control can be performed by utilization of tracking information acquired from the tracking information areas.

These tracking information areas can be formed even in the disappeared areas 4A and 4B, either, by merely leaving the non-disappeared areas 4E and 4F on both sides of the helical hologram strip 4 achieved in its widthwise direction orthogonal to its longitudinal direction. Hence, the tracking information areas can be made in an extremely stable fashion.

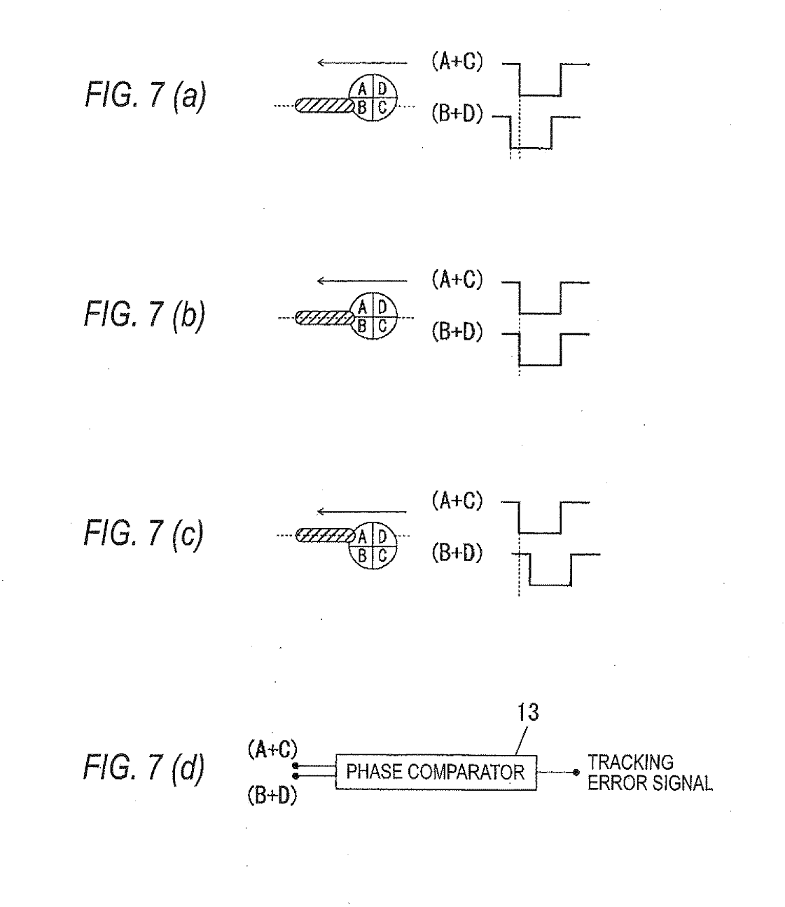

FIGS. 6 and 7 are for describing a state in which tracking is effected by means of tracking information acquired from the tracking information areas.

A phase difference method and a three beam method are available as a tracking control method. Since these control methods are well known, only brief explanations are provided to these methods.

FIG. 6 shows tracking control performed during regeneration operation. Since the laser beam (the circular beam) 5A emitted from the laser light source 5 is employed in regeneration operation, there is employed the laser beam 5A equal in size to one that actually appears in the helical hologram strip 4.

When such a laser beam (the circular beam) 5A is swept across and irradiated on the helical hologram strip 4, a phase comparator (designated by reference numeral 13 shown in FIG. 7 (d)) connected to the light receiving element 17 shown in FIG. 1 detects an inner or outer shift by means of the tracking information acquired from the tracking information areas on both sides of the helical hologram strip 4 that are orthogonal to the longitudinal direction of the hologram strip.

FIG. 7 (b) shows that there is no tracking offset. Since a phase of a combination of the laser beams A and C and a phase of a combination of the laser beams B and D, which are achieved in the phase comparator 13 taking into account a phase, become equal to each other, tracking control of the objective lens 11 is not performed.

FIG. 7 (a) shows a state in which the laser beam (the circular beam) 5A is offset to the non-disappeared area 4F of the helical hologram strip 4. The phase of the combination of the laser beams B and D is detected faster than is the phase of the combination of the laser beams A and C at this time. Therefore, the state where the laser beam is offset to the non-disappeared area 4F is detected, with the result that tracking control for returning the objective lens 11 to the center is performed.

FIG. 7 (c) shows that the laser beam (the circular beam) 5A is offset to the non-disappeared area 4E of the helical hologram strip 4. Since the phase of the combination of the laser beams A and C is detected faster than is the phase of the combination of the laser beams B and D. Therefore, a state in which the laser beam is offset to the non-disappeared area 4E is detected, with the result that tracking control for returning the objective lens 11 to the center is performed.

As mentioned above, according to the present embodiment, appropriate tracking control can be performed by utilization of tracking information acquired from the tracking information areas.

Regeneration operation is now described.

Since the laser beam to be irradiated on the helical hologram strip 4 is made less intensive during regeneration operation (that is one-tenth of the power of the laser beam achieved during recording operation), optical alterations do not arise in the helical hologram strip 4. The light receiving element 17 is arranged so as to do nothing but receive a beam reflected from the helical hologram strip 4, thereby obtaining a regeneration signal.

The beam reflected from the helical hologram strip 4 transmits through the spherical aberration correction plate 10 and passes through the quarter wavelength plate 9, thereby changing from the circularly polarized beam into a P polarized beam. The P polarized beam transmits through the corner cube array 8 and reaches the beam splitter 7, to thus transmit through the beam splitter 7.

A half of the S polarized beam reflected from the corner cube array 8 also transmits through the beam splitter. The S polarized beam that is reflected from the corner cube array 8 and the P polarized beam that is reflected from the helical hologram strip 4 are guided to the reflection plate 12.

The beam passes through the reflection plate 12 and the astigmatizer lens 13, to thus be split into three beams by the diffraction grating 14.

When the thus-split regeneration beams are taken as 18a, 18b, and 18c, respectively, the center regeneration beam 18b is the 0^{th} order diffracted beam and used for focus control and previously-described tracking control.

The left regeneration beam 18a is the +1^{st} order diffraction beam, and the right regeneration beam 18c is the −1^{st} order diffraction beam. They are used as signal beams for data read from the hologram disc (MH) 1. The regeneration beam 18a is a linearly polarized beam that is a combination of the high-intensity S polarized beam reflected from the reflection plate 12 with the weak P polarized beam reflected from the helical hologram strip 4. After having been converted into a circularly polarized beam by means of the quarter wavelength plate 15, the regeneration beam is split, by the polarized beam hologram 16, into two mutually orthogonal polarized beams having substantially equal amounts of light. The light receiving element 17 detects the two polarized beams as RF1 and RF2 signals.

The regeneration beam 18c is a linearly polarized beam that is a combination of the high-intensity S polarized beam reflected from the reflection plate 12 with the weak P polarized beam reflected from the helical hologram strip 4. The polarized beam hologram 16 splits the regeneration beam into two mutually orthogonal polarized beams having substantially equal amounts of light, and the light receiving element 17 detects the two polarized beams as RF3 and RF4 signals.

In the present embodiment, the RF1 to RF4 signals are computed, whereby data recorded in the helical hologram strip 4 are read.

When a signal beam, which is a beam reflected from the helical hologram strip 4, is read, a weak signal beam can be amplified by utilization of the beam reflected from the corner cube array 8. Therefore, the signal beam can be read with reliability, so that read accuracy can be enhanced.

Specifically, the beam reflected from the corner cube array 8 corresponds to direct reflection of the beam from the laser light source 5. Therefore, the signal beam can generally be intensified by a factor of 100 or thereabouts as compared with the intensity of the signal beam that is a beam reflected from the helical hologram strip 4 having a reflectance of several percents or less. For this reason, the beam reflected from the corner cube array 8 is caused to interfere with the signal beam that is the beam reflected from the helical hologram strip 4, thereby modulating the high-intensity beam reflected from the corner cubes 8 by means of the signal beam that is a beam reflected from the helical hologram strip 4. Modulation of the high-intensity beam reflected from the corner cube array 8 can be utilized as a signal for amplifying the signal beam. Hence, the light receiving element 17 can read the signal beam with reliability, and read accuracy can be enhanced.

In the embodiment, the beam emitted from the laser light source 5 is taken as the S polarized beam for the sake of convenience. However, the beam can also be the P polarized beam. In such a case, all you have to de is to change conditions, such as the beam splitter 7, as required.

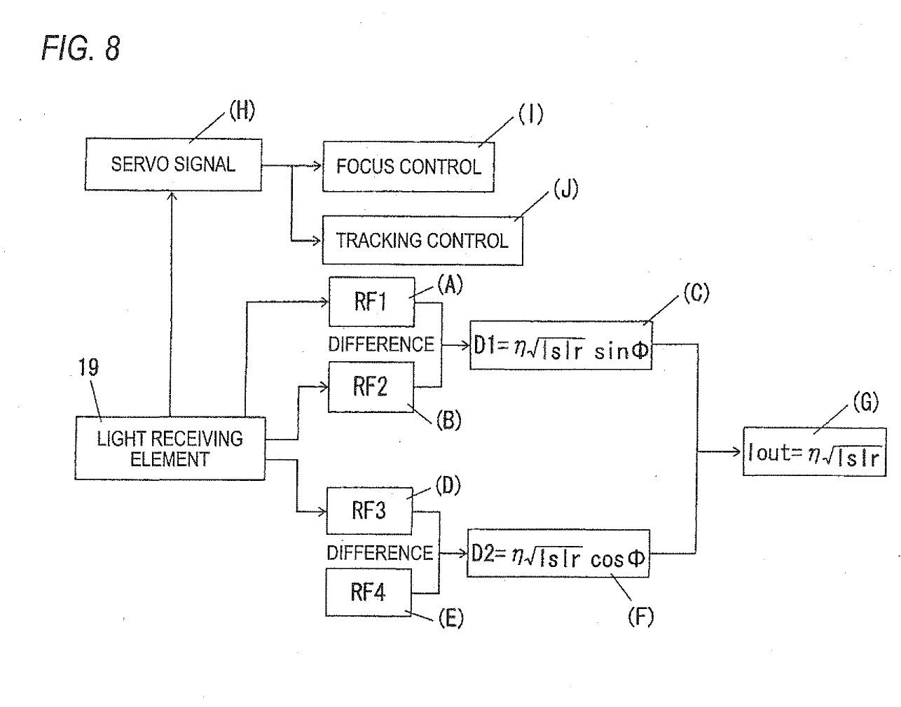

Data reading performed during regeneration operation is now described in detail by reference to FIG. 8.

In FIG. 8, a D1 ((C) of FIG. 8) provided in (Mathematical Expression 1) is derived from a difference between the RF1 signal ((A) of FIG. 8) and the RF2 signal ((B) of FIG. 8) that have been read from the regeneration beam (designated by reference numeral 18a shown in FIG. 1) by means of the light receiving element 17.

D1=η\sqrt{IₛIᵣ} sin φ [Mathematical Expression 1]

In the expression, reference symbol η designates a coefficient used for converting the incident beam from the light receiving element 17 into an electric signal; Iₛ designates beam intensity acquired from the beam reflected from the helical hologram strip 4; Iᵣ designates beam intensity acquired from the beams reflected from the corner cube array 8; φ designates an optical path length of a signal beam reflected from the helical hologram strip 4; and a phase difference stemming from a difference in optical path length of the beam reflected from the corner cube array 8.

D2 ((F) of FIG. 8) provided in (Mathematical Expression 2) is computed from a difference between the RF3 signal ((D) of FIG. 8) and the RF4 signal (E of FIG. 8) that have been read from the regeneration beam (designated by reference numeral 18c in FIG. 1).

D2=η\sqrt{IₛIᵣ} sin φ [Mathematical Expression 2]

D1 ((C) of FIG. 8) and D2 ((F) of FIG. 8) are squared, and a square root of a sum of the squares is computed, whereby an output signal Iₒᵤₜ ((G) of FIG. 8) is obtained as expressed by (Mathematical Expression 3).

Iₒᵤₜ=η\sqrt{IₛIᵣ} [Mathematical Expression 3]

The related art method is compared with the method of the embodiment. When a signal beam is read by means of the related art method that does not use the beam reflected from the corner cube array 8, an output signal I′ₒᵤₜ comes to ηIₛ. Hence, a ratio of the output signal obtained by the related art method to the output signal obtained by the method of the present embodiment is expressed as follows (Mathematical Expression 4).

$$\frac{{I}_{out}}{{I}_{out}^{′}} = \sqrt{\frac{{I}_{r}}{{I}_{s}}} \qquad [ Mathematical Expression 4 ]$$

Beam intensity Iᵣ of the beam reflected from the corner cube array 8 is generally greater than the beam intensity Iₛ of the beam reflected from the helical hologram strip 4. Therefore, the output signal is understood to be amplified as compared with that obtained under the related art method.

For instance, provided that Ix is 100 when Is is taken as one, the output signal is understood to be 10 times as much as that obtained under the related art method.

The beam reflected from the corner cube array 8 can thereby be utilized as an amplification signal for the signal beams, and an output signal can be amplified.

Upon computing the output signal Iₒᵤₜ as mentioned previously, the light receiving element 17 performs focus control ((I) of FIG. 8) and tracking control ((J) of FIG. 8) of a servo signal ((H) of FIG. 8).

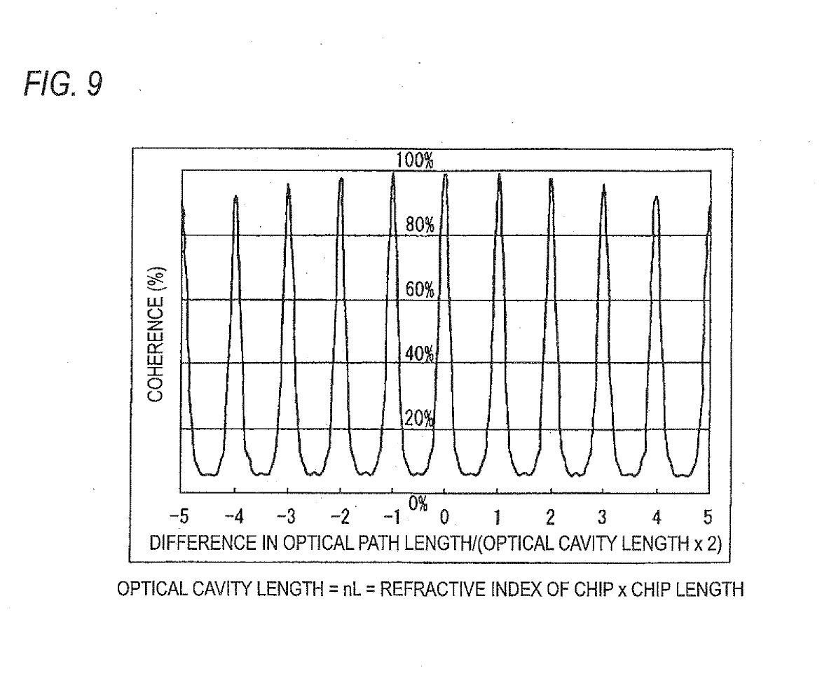

Under the previously-described homodyne detection method, the beam reflected from the corner cube array 8 and a signal beam that is a beam reflected from the helical hologram strip 4 are required to exhibit coherence. The semiconductor laser light source employed in an optical disc drive is used in a multimode in many cases while a high frequency is superimposed on a laser. As shown in FIG. 9, a difference between optical path lengths of two beams is taken for a horizontal axis while a value that is twice an optical cavity length is taken as a unit, and coherence is taken for a vertical axis. Under the conditions, high coherence is accomplished only when the difference between the optical path lengths of the two beams is in the vicinity of an integral multiple of a value that is twice the optical cavity length of the semiconductor laser. Coherence is low in the other range. Therefore, when such a semiconductor laser is used and in order to make amplification of the signal beam by the homodyne detection method effective, a difference between the optical path length, from the laser light source 5, of the beam reflected from the corner cube array 8 and the optical path length, from the laser light source 5, of the signal beam that is a beam reflected from the helical hologram strip 4 must be set to a substantially integral multiple of a value that is twice the optical cavity length of the laser light source 5. Incidentally, the optical cavity length is nL resultant from multiplication of a chip length L of the semiconductor laser chip by a refractive index “n” of the chip.

As mentioned above, a laser beam having appropriate intensity is irradiated on the helical hologram strip 4 without regard to the number of a hologram layer, as shown in FIGS. 4 through 6. The beam reflected from the helical hologram strip 4 reaches the corner cube array 8 by way of the objective lens 11 and the quarter wavelength plate 9.

The corner cube array 8 is configured so as to be able to exhibit a full aperture characteristic for a reflected beam traveling from the objective lens 11 toward the light receiving element 17. Namely, the corner cube array 8 is configured so as to be able to permit transmission of all reflected beams. Therefore, the corner cube array permits all of the reflected beams to travel toward the beam splitter 7.

The reflected beam from the helical hologram strip 4 in the middle of passing toward the beam splitter 7 has already traveled, back and forth, through the quarter wavelength plate 9 twice, with the result that the reflected beam is polarized from an S polarized wave to a P polarized wave. As a consequence, the reflected beam passes through the beam splitter 7, to thus reach the light receiving element 17 as mentioned above, and reading of the reflected beam is performed.

As is well known, the light receiving element 17 performs reading operation in recording operation and in regeneration operation, as well.

In so doing, when the signal beam that is a beam reflected from the helical hologram strip 4 is read, the beam reflected from the corner cube array 8 can be utilized. The signal beam can be read with reliability, and read accuracy can be enhanced.

The beam reflected from the corner cube array 8 corresponds to direct reflection of the beam from the laser light source 5. Hence, the intensity of the beams is generally about 100 times as high as the intensity of the signal beam that is a beam reflected from the helical hologram strip 4. Therefore, the high-intensity beam reflected from the corner cube array 8 can be utilized as a signal for amplifying the signal beam. Therefore, beam intensity can be increased by modulation of the signal beam to be read by the light receiving element 17, with the result that the light receiving element 17 can read the signal beam with reliability, and read accuracy can be enhanced.

### Second Embodiment

A second embodiment is for making the corner cube array smaller than the size of a spot of a beam entering the corner cube array. Elements that are analogous to those described in connection with the first embodiment are assigned the same reference numerals, and the detailed descriptions of the elements provided in connection with the first embodiment are quoted.

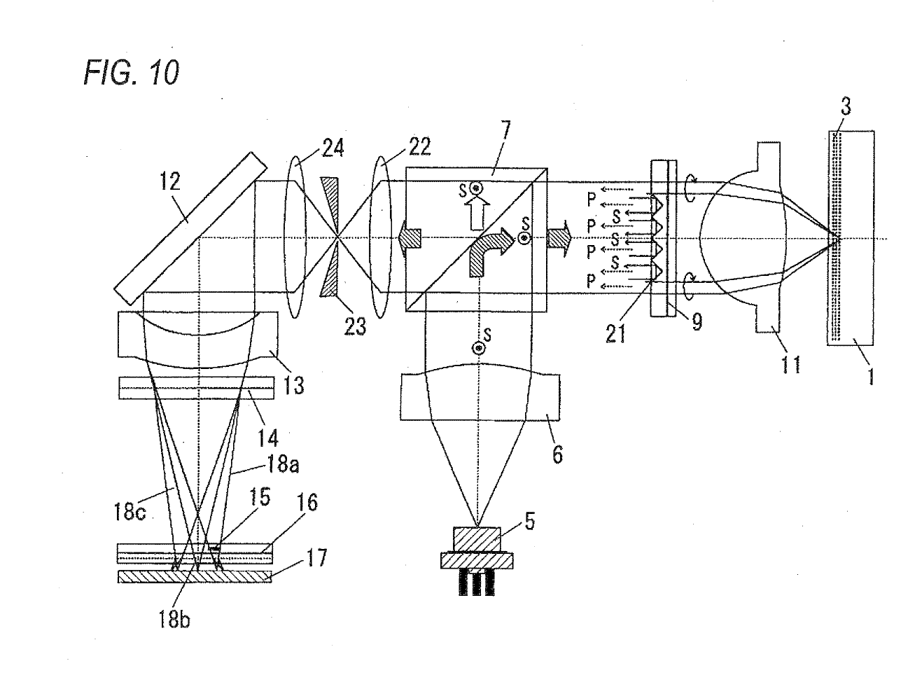

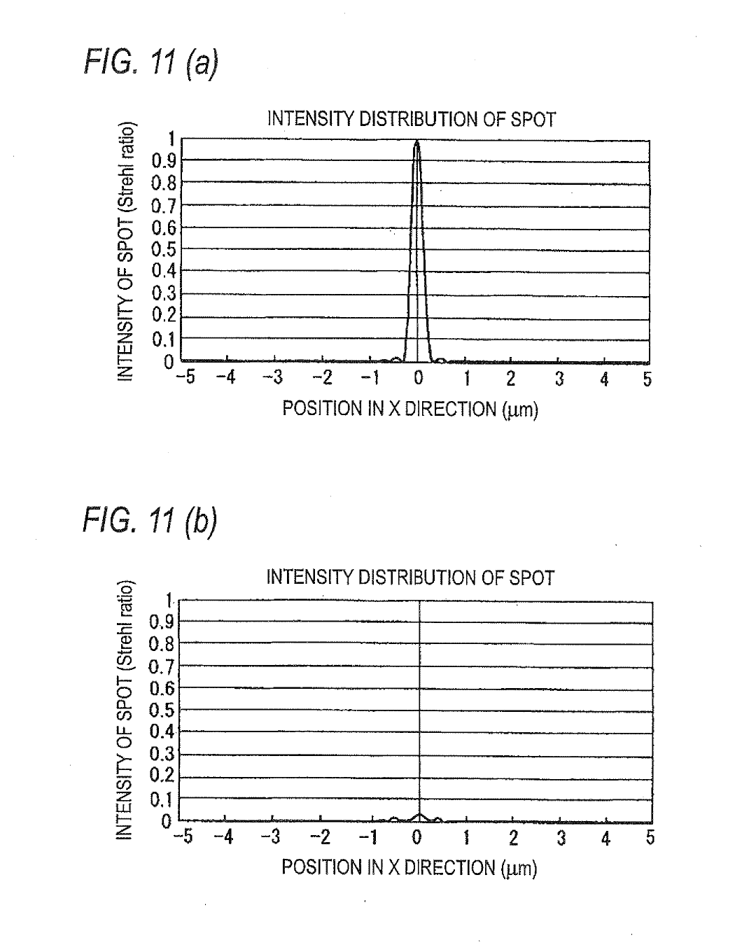

As shown in FIG. 10, in the present embodiment, a corner cube array 21 that is smaller than the spot of an incident beam from the beam splitter 7 is provided in place of the spherical aberration correction plate. A lens 22 for collecting a beam from the beam splitter 7, an aperture limit plate 23 made of a pinhole, or the like, and a lens 24 for converting a beam from the aperture limit plate 23 into a collimated beam are interposed between the beam splitter 7 and the reflection plate 12.

Unlike the corner cube array of the first embodiment, the corner cube array 21 of the embodiment is arranged to reflect all of specific polarized beams (the S polarized beam in the embodiment).

There is now described operation performed when the electronic device configured as mentioned above performs recording and regeneration of data in and from the helical hologram layer 3 formed in the hologram disc (MH) 1.

First, operation of the electronic device performed during recording operation is described.

In FIG. 10, a blue laser beam (405 nm) emitted as; for instance, an S polarized beam, from the laser light source 5 passes through the collimator lens 6.

A half of the laser beam passed through the collimator lens 6 undergoes reflection on the beam splitter 7, to thus travel toward the objective lens 11. A remaining half of the laser beam passes through the beam splitter 7.

In the laser beam reflected by the beam splitter 7, a portion of the beam passing through an area where the corner cube array 21 is present undergoes reflection. An outer periphery portion of the laser beam passing through the area where the corner cube array 21 is absent passes through the quarter wavelength plate 9. The thus-passed portion of the laser beam is irradiated, as a circularly polarized beam, on a target helical hologram strip 4 by mean of the objective lens 11, whereby recording is effected.

In the present embodiment, during recording operation, the blue laser beam emitted from the laser light source 5 is irradiated on the helical hologram strip 4 of a target layer, whereupon irradiated portions of the helical hologram strip 4 disappear.

Regeneration operation is now described.

The beam reflected from the helical hologram strip 4 passes through the quarter wavelength plate 9, to thus change from the circularly polarized beam into the P polarized beam. A center portion of the reflected beam transmits through the corner cube array 21. A peripheral portion of the reflected beam reaches without modification to the beam splitter 7 along with the beam transmitted through the corner cube array 21 and then transmits through the beam splitter 7.

A half of the S polarized beam reflected from the corner cube array 21 transmits through the beam splitter 7. The S polarized beam reflected by the corner cube array 8 and the P polarized beam that is a beam reflected from the helical hologram strip 4 are guided to the lens 22.

The beams guided to the lens 22 are collected and pass through the aperture limit plate 23 and are again converted into a collimated beam by the lens 24.

The collimated beam passes through the reflection plate 12 and the astigmatizer lens 13 and is split by the diffraction grating 14 into three beams.

Provided that the thus-split regeneration beams are taken as 18a, 18b, and 18c, the center regeneration beam 18b is used for focus control or previously-described tracking control.

The right and left regeneration beams 18a and 18c are used as signal beams of the data read from the hologram disc (MH) 1. After having been converted into a circularly polarized beam by the quarter wavelength plate 15, the regeneration beam 18a is split into two mutually orthogonal polarized beams having substantially equal amounts of light by the polarized beam hologram 16. The light receiving element 17 detects the two polarized beams as the RF1 and RF2 signals.

The polarized beam hologram 16 splits the regeneration beam 18c into two mutually orthogonal polarized beams having substantially equal amounts of light, and the light receiving element 17 detects the two polarized beams as the RF3 and RF4 signals.

In the present embodiment, the RF1 through RF4 signals are computed, whereby data recorded in the helical hologram strip 4 are read.

On occasion of reading of a signal beam that is a beam reflected from the helical hologram strip 4, a weak signal beam can be amplified by utilization of the beam reflected from the corner cube array 8. Hence, the signal beam can be read with reliability, and read accuracy can be enhanced.

Detailed descriptions are given to a characteristic point of the present embodiment that only an outer periphery portion of the laser beam is utilized.

In the embodiment, the corner cube array 21 irradiates only an outer periphery portion of the beam reflected from the beam splitter 7 toward the helical hologram strip 4 of the hologram disc (MH) 1 by way of the objective lens 11.

Before explanation of superior of the present embodiment, an explanation is given to a case (a related art) where there is no spherical aberration correction plate and where there is not provided the corner cube array 21, by reference to FIGS. 11 (a) and (b). Since the corner cube array 21 is not provided in this case, a beam passes through the entire surface of the lens.

FIG. 11 (a) shows an intensity distribution of a spot on a helical hologram strip 4 of a first layer in the hologram disc (MH) 1 situated opposite the objective lens 11. A relative distance between the objective lens 11 and the hologram disc (MH) 1 achieved at this time is adjusted such that the spot comes into a focus on the helical hologram strip 4 of the first layer.

What is understood from FIG. 11 (a) is that a laser beam having sufficient intensity can be supplied to the helical hologram strip 4 of the first layer, so long as; for instance, specifications of the objective lens 11, are properly set.

FIG. 11 (b) shows an intensity distribution of a spot on a helical hologram strip 4 of a thirtieth layer in the hologram disc (MH) 1 from the objective lens 11. A relative distance between the objective lens 11 and the hologram disc (MH) 1 achieved at this time is adjusted such that the spot comes into focus on the helical hologram strip 4 of the thirtieth layer.

What is understood from FIG. 11 (b) is that a laser beam having sufficient intensity cannot be supplied to the center of the spot on the helical hologram strip 4 of the thirtieth layer from the objective lens 11; namely, on a layer distant from a top layer.

The following is a reason for the incapability of supplying a laser beam having sufficient intensity to the helical hologram strip 4 of a layer distant from the top layer. Namely, a change arises in the thickness of the hologram disc (MH) 1 through which an outgoing laser beam from the objective lens 11 passes before reaching a focal point, thereby changing an optical path length, with the result that spherical aberration occurs.

In the present embodiment, in order to correct the spherical aberration, the corner cube array 21 that guides only an outer periphery portion of the laser beam to the objective lens 11 is interposed between the laser light source 5, which is employed as an example light emitting element as mentioned previously, and the objective lens 11, as shown in FIG. 10. Specifically, the shape of the corner cube array 21 is determined as mentioned above, without use of the spherical aberration correction plate that is employed in the first embodiment.

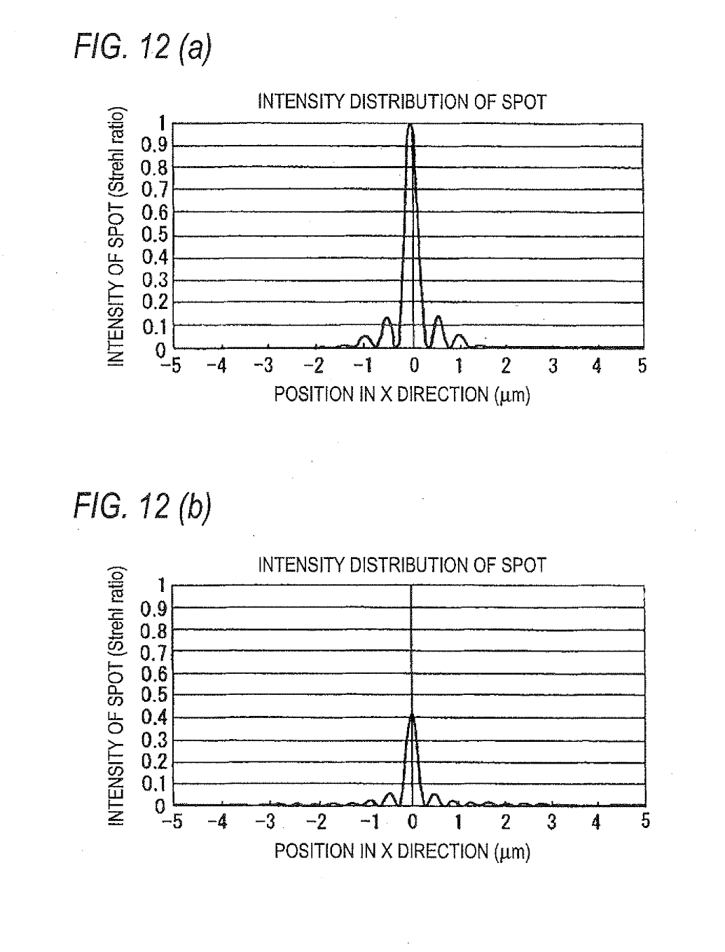

FIG. 12 (a) shows an intensity distribution of a spot on the helical hologram strip 4 of the first layer in the hologram disc (MH) 1 of the embodiment shown in FIG. 1, which is opposite the objective lens 11. The relative distance between the objective lens 11 and the hologram disc (MH) 1 achieved at this time is adjusted such that the spot comes into a focus on the helical hologram strip 4 of the first layer.

What is understood from FIG. 12 (a) is that a laser beam having sufficient intensity can be supplied to the helical hologram strip 4 of the first layer.

FIG. 12 (b) shows an intensity distribution of a spot on the helical hologram strip 4 of the thirtieth layer in the hologram disc (MH) 1 from the objective lens 11. The relative distance between the objective lens 11 and the hologram disc (MH) 1 achieved at this time is adjusted such that the spot comes into a focus on the helical hologram strip 4 of the thirtieth layer.

What is understood from FIG. 12 (b) is that the laser beam having sufficiently practicable intensity can be supplied to the helical hologram strip 4 of the thirtieth layer from the objective lens 11; namely, a center of a spot even on a helical hologram strip 4 of a layer distant from the top layer.

Explanations are now given to why, in the embodiment, the laser beam having sufficiently practicable intensity can be supplied even to the helical hologram strip 4 of a layer distant from the top layer.

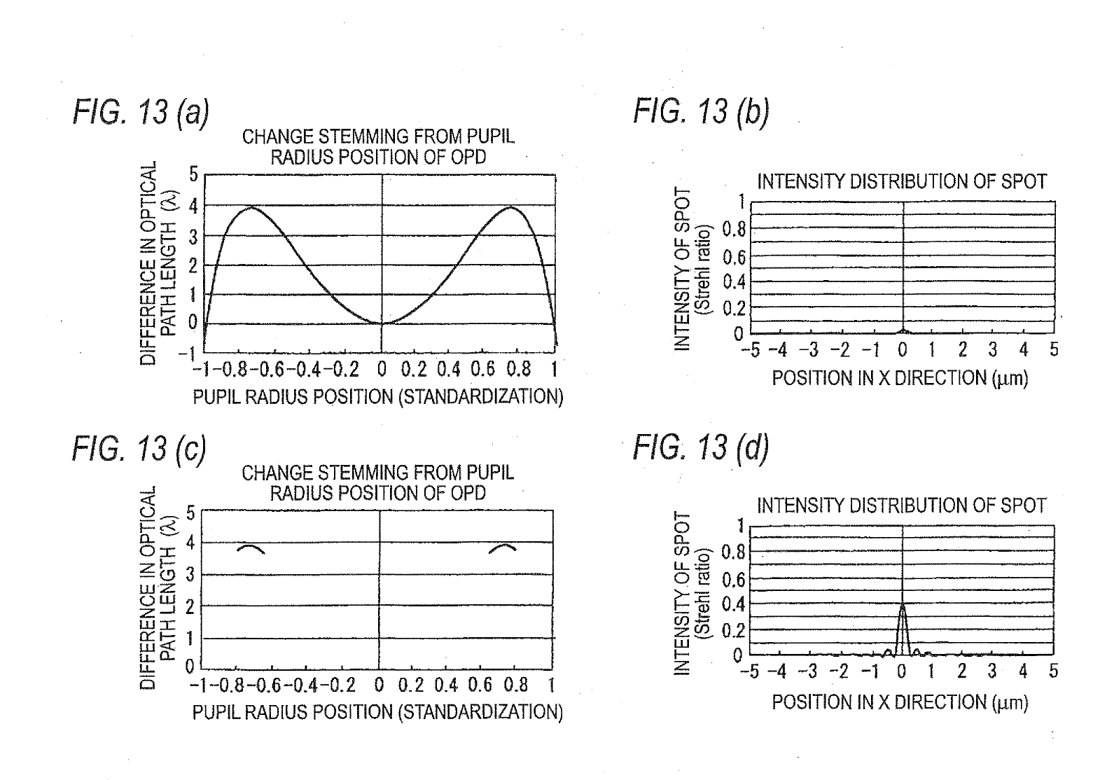

FIG. 13 (a) shows a state shown in FIG. 11 (b); namely, a difference in optical path length of a beam that reaches the helical hologram strip 4 of the thirtieth layer in the hologram disc (MH) 1 from the object lens 11.

The following is what is understood from FIG. 13 (a). Namely, when all of the laser beams originated from the laser light source 5 are irradiated on the helical hologram strip 4 of the hologram disc (MH) 1 by way of the objective lens 11, a difference in optical path length of; for instance, the helical hologram strip 4 of the thirtieth layer, greatly varies as a beam passage position moves away from the center of the objective lens 11.

Therefore, as also shown in FIG. 13 (b), it comes to be difficult to supply a laser beam having sufficient intensity to the helical hologram strip 4 of the thirtieth layer from the objective lens 11; namely, a layer distant from the top layer.

On the contrary, FIG. 13 (c) shows a difference in optical path length of the beam reaching the helical hologram strip 4 of the thirtieth layer from the objective lens 11 in the hologram disc (MH) 1 while the corner cube array 8 of the present embodiment is interposed between the laser light source 5, which is used as an example light emitting element, and the objective lens 11 as shown in FIG. 1.

In FIG. 13 (c), a horizontal axis represents a distance from the center of the beam passage position on the objective lens 11, and a vertical axis represents a difference in optical path length. As can be understood from FIG. 13 (c), the laser beam passed through the outer periphery of the corner cube array 21 is limited in terms of a distance from the center of the objective lens 11, and the difference in optical path length becomes small within the thus-limited range, too.

FIG. 13 (d) shows an intensity distribution of a spot achieved when the laser beam in the state shown in FIG. 13 (c) is irradiated on the helical hologram strip 4 of the thirtieth layer from the objective lens 11 by way of the objective lens 11.

As is obvious from a comparison between FIG. 13 (d) and FIG. 11 (b) showing a comparative example, it is understood that the electronic device of the present embodiment can supply a laser beam having sufficiently practicable intensity on the helical hologram strip 4 of the thirtieth layer from the objective lens 11; namely, on a helical hologram strip 4 of a layer distant from the top layer.

In the present embodiment, regardless of the number of a layer to which the helical hologram strip 4 belongs, the beam shown in FIG. 13 (c) (the beam that is limited in terms of a distance from the center of the objective lens 11 and that involves a small difference in optical path length within the limited range) is supplied to the helical hologram strip 4. Therefore, a laser beam having sufficient intensity can be supplied to the helical hologram strip 4 of any layer without use of the spherical aberration correction element.

By second reference to FIGS. 12 (a) and (b), explanations are given to this point. Namely, according to the present embodiment, a laser beam having sufficiently practicable intensity can be supplied to the helical hologram strip 4 of the first layer from the objective lens 11 as shown in FIG. 12(a) and also to the helical hologram strip 4 of the thirtieth layer from the objective lens 11 as shown in FIG. 12 (b), without use of a spherical aberration correction element.

The aperture limit plate 23 is interposed between the beam splitter 7 and the reflection plate 12.

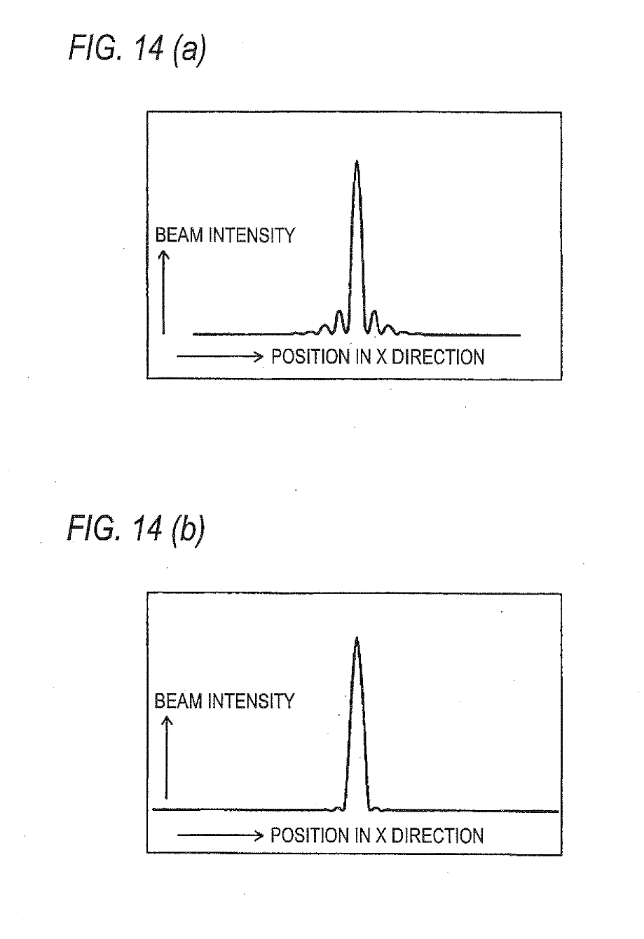

The reason for this is that noise components are included in both sides of a center portion of the laser beam traveling toward the objective lens 11, as shown in FIG. 14(a), as a result of the corner cube array 21 being provided. Thereby, noise components are also included in both sides of a center portion of the reflected beam traveling toward the light receiving element 17. The aperture limit plate is for eliminating the noise components before the reflected beam reaches the light receiving element 17.

Namely, there is implemented a configuration for letting the aperture limit plate 23 permit transmission of a reflected beam, thereby eliminating the noise components from the reflected beam traveling toward the light receiving element 17, as shown in FIG. 14(b), to thus enhance recording and regeneration accuracy.

In the second embodiment, by adoption of the above configuration, the beam reflected from the corner cube array 21 can be utilized when a signal beam, which is a beam reflected from the helical hologram strip 4, is read. Therefore, the signal beam can be read with reliability, and read accuracy can be enhanced.

Only the outer peripheral portion of the laser beam is guided to the hologram disc (MH) 1 by means of the corner cube array 21, thereby enabling correction for spherical aberration. Specifically, a liquid crystal spherical aberration correction element is eliminated; therefore, miniaturization of the electronic device can be accomplished.

Therefore, the present invention can contribute to miniaturization of a portable-type electronic device as well as to miniaturization of a stationary electronic device.

In the present embodiment, the aperture limit plate 23 is provided. However, the aperture limit plate can be omitted as in the case of the first embodiment. However, in this case, noise components included in both sides of the center portion of the reflected beam traveling toward the light receiving element 17 also reach the light receiving element 17. Therefore, after received by the light receiving element 17, the noise components must be eliminated or dampened by means of signal processing.

If the aperture limit plate 23 is eliminated as in the first embodiment, a utilization factor of the reflected beam traveling from the beam splitter 7 toward the light receiving element 17 becomes grater; hence, it becomes easy for the light receiving element 17 to perform signal processing after receipt of the beam.

In the present embodiment, the corner cube array 21 permits transmission of all of the beams traveling from the objective lens 11 toward the light receiving element 17. However, there can also be adopted a configuration for allowing transmission of only the outer periphery portion of the laser beam as in the case of the beam traveling from the beam splitter 7 toward the objective lens 11.

In so doing, crosstalk from adjacent tracks in the helical hologram strip 4 can also be minimized.

As above, the electronic device of the present invention can read a regeneration beam with reliability and enhance read accuracy; therefore, the device is useful as a multilayer hologram disc player, or the like.

This application claims the benefit of Japanese Patent application No. 2009-190629 filed on Aug. 20, 2010, the entire contents of which are incorporated herein by reference.

What is claimed is:

1. An electronic device that performs at least recording or regeneration of data in or from a hologram disc, comprising:
an objective lens disposed opposite the hologram disc;
a light emitting element that emits a beam toward the objective lens; and
a light receiving element that receives a beam reflected from the hologram disc by way of the objective lens, wherein
a reflection plate for reflecting a portion of a beam traveling from the light emitting element toward the objective lens is interposed between the light emitting element and the objective lens.

2. The electronic device according to claim 1, wherein the reflection plate permits transmission of only an outer periphery portion of the beam traveling from the light emitting element toward the objective lens and reflects an inner periphery portion of the beam.

3. The electronic device according to claim 1, wherein the reflection plate permits transmission of the beam traveling from the objective lens toward the light receiving element.

4. The electronic device according to claim 1, wherein polarized beam of the beam traveling toward the objective lens after having transmitted through the reflection plate and polarized beam of the beam entering the reflection plate after having undergone reflection on the hologram disc are substantially orthogonal to each other.

5. The electronic device according to claim 1, wherein a diffraction grating for splitting the beam traveling from the objective lens and the reflection plate toward the light receiving element into a first beam, a second beam, and a third beam is interposed between the reflection plate and the light receiving element.

6. The electronic device according to claim 5, wherein, on reading the first and second beams, the light receiving element splits the first beam into two mutually orthogonal polarized beams, splits the second beam into two mutually orthogonal polarized beams after having changed a polarized state of the second beam, and reads the respective polarized beams.

7. The electronic device according to claim 5, wherein the third beam is utilized for at least focus control or tracking control.

8. The electronic device according to claim 1, wherein the reflection plate has a corner cube array in which a plurality of corner cubes are arranged in a planar pattern; a first member disposed on an incident plane side of the reflection plate which a beam emitted from the light emitting element enters; and a second member disposed on a surface side opposite to the incident surface; the corner cube array, the first member, and the second member are formed integrally; and a refractive index of the first member and a refractive index of the second member are identical with each other.

9. The electronic device according to claim 1, wherein the light emitting element is a semiconductor laser, and a difference between an optical path length, from the light emitting element, of the beam traveling toward the light receiving element after having undergone reflection on the reflection plate and an optical path length, from the light emitting element, of the beam traveling from the light emitting element toward the light receiving element after having undergone reflection on the hologram disc is substantially an integral multiple of a value that is twice an optical cavity length of the semiconductor laser.
